(19) United States
(12) Patent Application Publication
(10) Pub. No.: US 2020/0409019 A1
(43) Pub. Date: Dec. 31, 2020

(54) LENS MODULE

(71) Applicant: AAC Optics Solutions Pte. Ltd., Singapore city (SG)

(72) Inventor: Chuandong Wei, Shenzhen (CN)

(21) Appl. No.: 16/914,491

(22) Filed: Jun. 29, 2020

(30) Foreign Application Priority Data
Jun. 29, 2019 (CN) PCT/CN2019/094027

(51) Int. Cl. G02B 7/02; G02B 13/00

(52) U.S. Cl. CPC G02B 7/021; G02B 7/026; G02B 13/0045

(57) ABSTRACT

A lens module is provided, including a lens barrel with an accommodation space and a lens group. The lens barrel includes a first barrel wall with a light through hole and a second barrel wall. The lens module includes an annular supporting member fixed to one end of second barrel wall that is adjacent to an image side. The supporting member with through hole and the second barrel wall with protrusion, which respectively include an inner and inner side surface adjacent to optical axis, and the first barrel wall surround to form accommodation space. A minimum distance between inner surface of supporting member and optical axis is greater than a maximum distance between inner side surface of second barrel wall and optical axis. The protrusion is fitted and fixed with through hole. Compared with the related technology, the lens module provided in the present disclosure has good imaging quality.

### TECHNICAL FIELD

The present disclosure relates to the field of optical imaging, in particularly to a lens module.

### BACKGROUND

In recent years, with the continuous development of science and technology, electronic devices are continuously developing towards intelligence. In addition to digital cameras, portable electronic devices such as tablet computers and mobile phones are also equipped with lens modules having photo shooting and video shooting functions, as well as vehicles such as cars are equipped with the lens modules having the photo shooting and video shooting functions, so as to meet the needs of users to take photos at any time.

The lens module in the related technology includes a lens barrel and a lens group accommodated in the lens barrel. In order to enable the lens barrel to support and fix the lens group sufficiently, a side wall of the lens barrel usually needs to reach a certain thickness to support and fix the lens group. For the lens barrel with too thick side wall, as shown in FIG. 1, due to a reflection effect of the inner wall of the lens barrel on the light, the light emitted to the lens group from various angles is easy to form stray light interference in the lens barrel during imaging. In particular, one end of the side wall of the lens barrel that is adjacent to an image side is a portion where external light is very easy to reflect after entering the lens barrel, thus obvious stray light is easy to appear in the photographed picture, resulting in poor imaging quality of the lens module.

Therefore, it is necessary to provide an improved lens module to solve the above problems.

### SUMMARY

With respect to the technical problem that a lens is easy to generate stray light due to a light reflection effect of an inner wall of a lens barrel in a lens module in the related technology which causes poor imaging quality of the lens module, the present disclosure provides a lens module which is able to prevent the stray light effectively and has good reliability.

A lens module includes a lens barrel with an accommodation space and a lens group accommodated in the accommodation space. The lens barrel includes a first barrel wall configured with a light through hole and a second barrel wall bending and extending from an outer side of the first barrel wall. The lens module further includes an annular supporting member fixed to one end of the second barrel wall adjacent to an image side. The supporting member, the second barrel wall and the first barrel wall jointly surround to form the accommodation space, the second barrel wall includes an inner side surface adjacent to an optical axis, the supporting member includes an inner surface adjacent to the optical axis, and a minimum distance between the inner surface of the supporting member and the optical axis is greater than a maximum distance between the inner side surface of the second barrel wall and the optical axis. The supporting member is further configured with a through hole penetrating through the supporting member, the second barrel wall is configured with a protrusion in a position corresponding to the through hole, and the protrusion is fitted and fixed with the through hole.

Preferably, the supporting member further includes an outer surface away from the optical axis and opposite to the inner surface, and the through hole is configured to penetrate through the inner surface and the outer surface.

Preferably, the second barrel wall further includes an outer side surface away from the optical axis, and the protrusion extends from the outer side surface in a direction away from the optical axis and fits into the through hole.

Preferably, the second barrel wall includes a first portion adjacent to an object side and a second portion bending and extending from one end of the first portion that is adjacent to an image side in a direction adjacent to the optical axis, and the protrusion extends from the second portion in the direction away from the optical axis.

Preferably, the supporting member includes a first supporting portion adjacent to the object side and abutting against the second barrel wall and a second supporting portion bending and extending from the first supporting portion in the direction away from the optical axis, and a thickness of the second supporting portion along the direction perpendicular to the optical axis is smaller than the thickness of the first supporting portion along the direction perpendicular to the optical axis.

Preferably, the through hole is configured to penetrate through the first supporting portion, and the second portion is fixedly connected to the first supporting portion by the protrusion.

Preferably, a plurality of through holes are provided, and the plurality of through holes are arranged at equal intervals surrounding the second barrel wall.

Preferably, the supporting member and the second barrel wall are injection-molded into an integration structure.

Preferably, the supporting member is made of a metal or plastic.

Compared with the related technology, in the lens module according to the present disclosure, the annular supporting member is provided at one end of the lens barrel that is adjacent to the image side, as the minimum distance between the inner surface of the supporting member and the optical axis is greater than the maximum distance between the inner side surface of the second barrel wall and the optical axis, the incidence of external light on the supporting member may be effectively reduced, thereby reducing the influence of the stray light phenomenon inside the lens group on the imaging quality and effectively improving the imaging quality. In addition, the second portion of the second barrel wall is configured with a protrusion structure, the first supporting portion of the supporting member is configured with the through hole penetrating through the first supporting portion, the second barrel wall is fitted and fixed with the supporting member through the protrusion, and the supporting member and the second barrel wall are injection-molded into the integration structure, which ensures good support of the lens barrel to the lens group for good reliability.

### BRIEF DESCRIPTION OF THE DRAWINGS

In order to illustrate the technical solution in the embodiments of the present disclosure more clearly, the accompanying drawings used in the description of the embodiments are briefly introduced below. It is apparent that the drawings descripted below are only some embodiments of the present disclosure. For those skilled in the art, other drawings may be obtained in accordance with these drawings without any creative work, where:

FIG. 1 is a cross-sectional view of a lens module in the related technology;

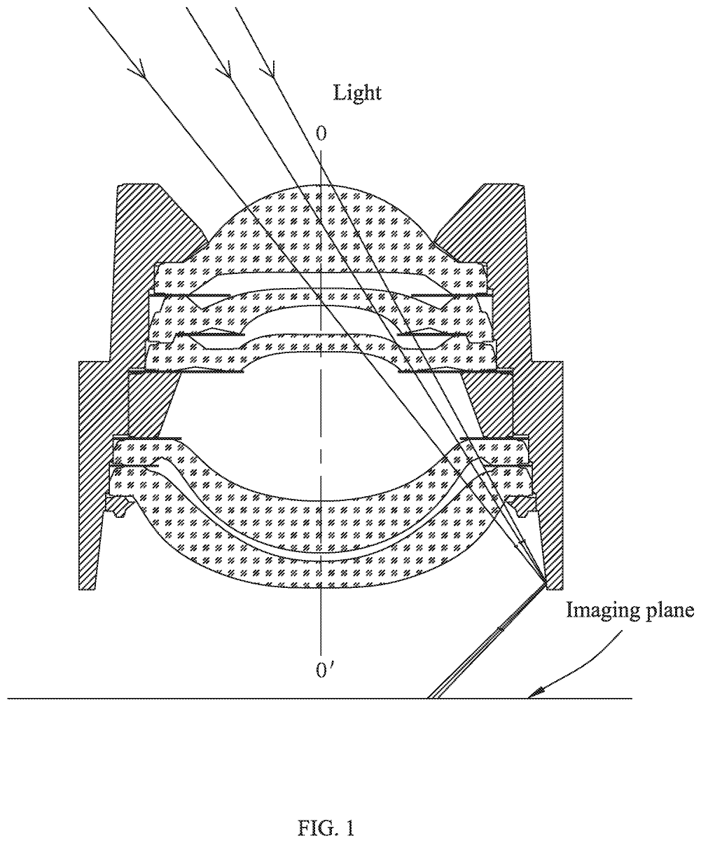

FIG. 2 is a cross-sectional view of the lens module provided in the present disclosure;

FIG. 3 is a partially exploded view of the lens module shown in FIG. 2; and

FIG. 4 is a partially enlarged view of a portion A shown in FIG. 3.

### DETAILED DESCRIPTION

The technical solutions in the embodiments of the present disclosure will be clearly and completely described with reference to the accompanying drawings in the present disclosure. It is evident that the embodiments described are only some rather than all embodiments in the present disclosure. Based on the embodiments in the present disclosure, all other embodiments obtained by those of ordinary skills in the art without any creative work shall fall within the protection scope of the present disclosure.

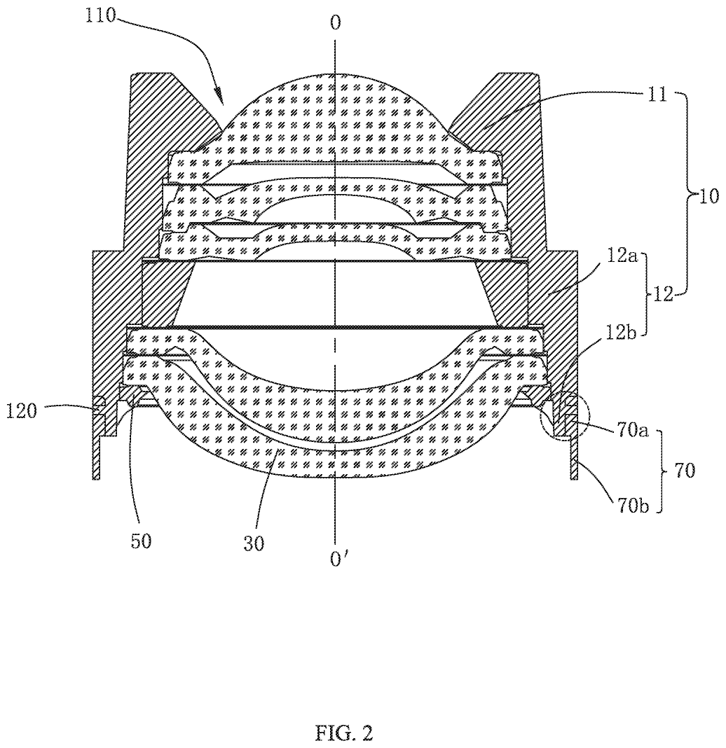

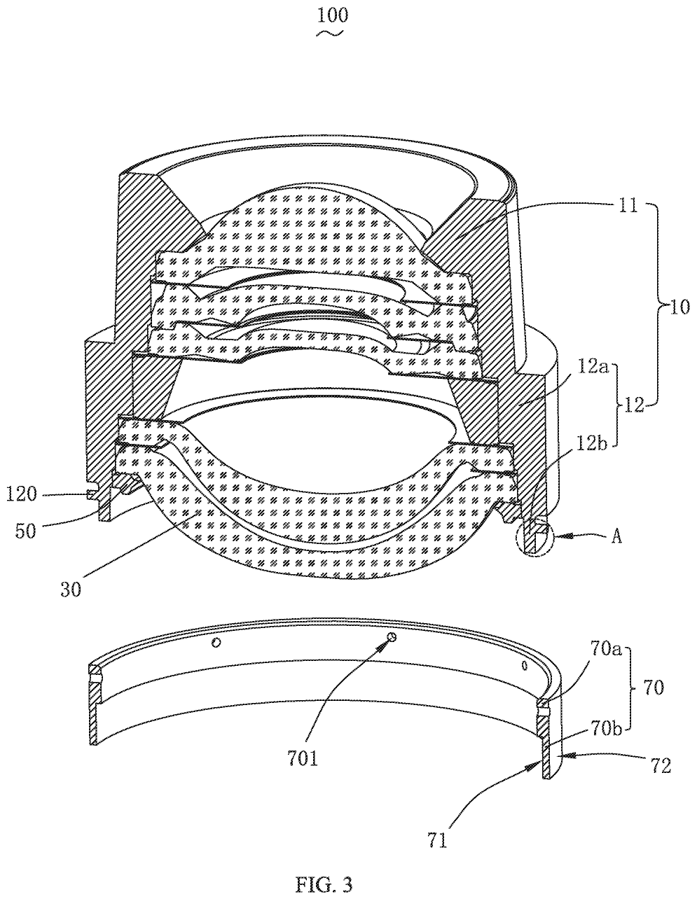

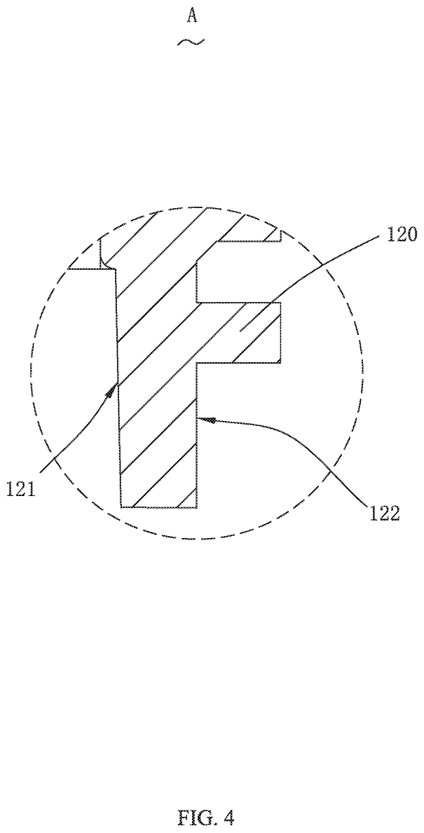

Referring to FIG. 2 to FIG. 4. This embodiment provides a lens module 100, which includes a lens barrel 10, a lens group 30 accommodated in the lens barrel 10, a press ring 50 that holds the lens group 30 in the lens barrel 10, and an annular supporting member 70 fixed to one end of the lens barrel 10 that is adjacent to an image side.

The lens barrel 10 includes a first barrel wall 11 configured with a light through hole 110 and a second barrel wall 12 bending and extending from the first barrel wall 11. The supporting member 70 is fixed to one end of the second barrel wall 12 that is adjacent to the image side. The supporting member 70, the second barrel wall 12 and the first barrel wall 11 jointly surround to form an accommodation space, and the accommodation space is configured to accommodate the lens group 30. The lens group 30 is sandwiched between the first barrel wall 11 and the press ring 50.

The second barrel wall 12 includes an inner side surface 121 adjacent to an optical axis 00′ and an outer side surface 122 away from and opposite to the inner side surface 121. The supporting member 70 includes an inner surface 71 adjacent to the optical axis 00′ and an outer surface 72 away from and opposite to the inner surface. A minimum distance between the inner surface 71 of the supporting member 70 and the optical axis 00′ is greater than a maximum distance between the inner side surface 121 of the second barrel wall 12 and the optical axis 00′. Since one end of the lens barrel 10 that is adjacent to an image side is a portion where reflection is very likely to occur after external light enters the lens barrel 10, in the present disclosure, the minimum distance between the inner surface 71 of the supporting member 70 and the optical axis 00′ is set to be greater than the maximum distance between the inner side surface 121 of the second barrel wall 12 and the optical axis 00′. That is, a thickness of the supporting member 70 is very thin, which may effectively reduce a case where stray light is incident into the lens barrel and reflected on the supporting member 70 thus affecting imaging quality, thereby reducing the stray light phenomenon inside the lens group and effectively improving the imaging quality.

In order to ensure the stability of a connection between the supporting member 70 and the second barrel wall 12, in this embodiment, the supporting member 70 is configured with a through hole 701. The through hole 701 is configured to penetrate through the inner surface 71 and the outer surface 72. The second barrel wall 12 is configured with a protrusion 120 in a position corresponding to the through hole 701. The protrusion 120 is fitted and fixed with the through hole 701.

Specifically, the second barrel wall 12 includes a first portion 12a adjacent to an object side and a second portion 12b bending and extending from one end of the first portion 12a that is adjacent to the image side in a direction adjacent to the optical axis 00′, and the protrusion 120 extends from the outer side surface 122 of the second portion 12b in the direction away from the optical axis 00′.

The supporting member 70 includes a first supporting portion 70a adjacent to the object side and abutting against the second barrel wall 12 and a second supporting portion 70b bending and extending from the first supporting portion 70a in the direction away from the optical axis 00′, and the thickness of the second supporting portion 70b along the direction perpendicular to the optical axis 00′ is smaller than the thickness of the first supporting portion 70a along the direction perpendicular to the optical axis 00′. The through hole 701 is configured to penetrate through the first supporting portion 70a, and the second portion 12b is fixedly connected to the first supporting portion 70a by the protrusion 120.

Preferably, a plurality of through holes 701 are provided, and the plurality of through holes 701 are arranged at equal intervals surrounding the second barrel wall 12, so that the peripheral sides of the second barrel wall 12 are fixed with the supporting member 70, and the stability of the connection between the supporting member 70 and the second barrel wall 12 is improved.

The supporting member 70 is made of a metal or plastic, and may achieve sufficient support strength.

The press ring 50 abuts against the inner side surface 121 of the second barrel wall 12. Preferably, the press ring 50 and the second barrel wall 12 are fixed by glue.

Compared with the related technology, in the lens module according to the present disclosure, the annular supporting member is provided at one end of the lens barrel that is adjacent to the image side, as the minimum distance between the inner surface of the supporting member and the optical axis is greater than the maximum distance between the inner side surface of the second barrel wall and the optical axis, the incidence of external light on the supporting member may be effectively reduced, thereby reducing the influence of the stray light phenomenon inside the lens group on the imaging quality and effectively improving the imaging quality. In addition, the second portion of the second barrel wall is configured with a protrusion structure, the first supporting portion of the supporting member is configured with the through hole penetrating through the first supporting portion, the second barrel wall is fitted and fixed with the supporting member through the protrusion, and the supporting member and the second barrel wall are injection-molded into the integration structure, which ensures good support of the lens barrel to the lens group for good reliability.

The above description is merely embodiments of the present disclosure, and it should be pointed out that, those of ordinary skills in the art are able to make improvements without departing from the inventive concept of the present disclosure, but these improvements all belong to the protection scope of the present disclosure.

What is claimed is:

1. A lens module, comprising a lens barrel with an accommodation space and a lens group accommodated in the accommodation space; the lens barrel comprising a first barrel wall configured with a light through hole and a second barrel wall bending and extending from an outer side of the first barrel wall; the lens module further comprising an annular supporting member fixed to one end of the second barrel wall that is adjacent to an image side; the supporting member, the second barrel wall and the first barrel wall jointly surrounding to form the accommodation space; the second barrel wall comprising an inner side surface adjacent to an optical axis, the supporting member comprising an inner surface adjacent to the optical axis, and a minimum distance between the inner surface of the supporting member and the optical axis being greater than a maximum distance between the inner side surface of the second barrel wall and the optical axis; the supporting member being further configured with a through hole penetrating through the supporting member, the second barrel wall being configured with a protrusion in a position corresponding to the through hole, and the protrusion being fitted and fixed with the through hole.

2. The lens module according to claim 1, wherein the supporting member further comprises an outer surface away from the optical axis and opposite to the inner surface, and the through hole is configured to penetrate through the inner surface and the outer surface.

3. The lens module according to claim 2, wherein the second barrel wall further comprises an outer side surface away from the optical axis, and the protrusion extends from the outer side surface in a direction away from the optical axis and fits into the through hole.

4. The lens module according to claim 3, wherein the second barrel wall comprises a first portion adjacent to an object side and a second portion bending and extending from one end of the first portion that is adjacent to an image side in the direction adjacent to the optical axis, and the protrusion extends from the second portion in the direction away from the optical axis.

5. The lens module according to claim 4, wherein the supporting member comprises a first supporting portion adjacent to the object side and abutting against the second barrel wall and a second supporting portion bending and extending from the first supporting portion in the direction away from the optical axis, and a thickness of the second supporting portion along the direction perpendicular to the optical axis is smaller than the thickness of the first supporting portion along the direction perpendicular to the optical axis.

6. The lens module according to claim 5, wherein the through hole is configured to penetrate through the first supporting portion, and the second portion is fixedly connected to the first supporting portion by the protrusion.

7. The lens module according to claim 1, wherein a plurality of through holes are provided, and the plurality of through holes are arranged at equal intervals surrounding the second barrel wall.

8. The lens module according to claim 1, wherein the supporting member and the second barrel wall are injection-molded into an integration structure.

9. The lens module according to claim 1, wherein the supporting member is made of a metal or plastic.

10. The lens module according to claim 1, wherein the lens module further comprises a press ring that holds the lens group in the accommodation space, and the press ring abuts against the inner side surface of the second barrel wall.
